(19) United States
(12) Patent Application Publication
(10) Pub. No.: US 2014/0380000 A1
(43) Pub. Date: Dec. 25, 2014

(54) MEMORY CONTROLLER AND ACCESSING SYSTEM UTILIZING THE SAME

(71) Applicant: Silicon Motion, Inc., Jhubei City (TW)

(72) Inventors: Yu-Wei CHYAN, Hsinchu City (TW); Jiyun-Wei LIN, Xinpu Township, Hsinchu County (TW)

(73) Assignee: Silicon Motion, Inc., Jhubei City (TW)

(21) Appl. No.: 14/107,165

(22) Filed: Dec. 16, 2013

Related U.S. Application Data
(60) Provisional application No. 61/837,529, filed on Jun. 20, 2013.

(30) Foreign Application Priority Data
Nov. 12, 2013 (TW) 102140986

(51) Int. Cl. G06F 3/06

(52) U.S. Cl. CPC G06F 3/0658; G06F 3/0604; G06F 3/0683
USPC 711/148

(57) ABSTRACT

A memory controller is coupled to a memory device including a first block and a second block and includes a first register module, a first execution unit and a second register module. The first register module includes a plurality of set registers to store a first configuration file and a second configuration file. The first execution unit computes data stored in the first block simultaneously according to the first and the second configuration files to generate a first computation result and a computation operation result. The second register module includes a plurality of result registers to store the first and the second computation results.

### CROSS REFERENCE TO RELATED APPLICATIONS

This application claims the benefit of U.S. Provisional Application No. 61/837,529 filed on Jun. 20, 2013, which is hereby incorporated by reference in its entirety.

This Application claims priority of Taiwan Patent Application No. 102140986, filed on Nov. 12, 2013, the entirety of which is incorporated by reference herein.

### BACKGROUND OF THE INVENTION

1. Field of the Invention

The invention relates to a memory controller, and more particularly to a memory controller computing data simultaneously according to several configuration files.

2. Description of the Related Art

A memory controller is coupled between a memory and a CPU to transmit and manage data. In conventional technology, the memory controller is integrated in a north bridge chip of a chipset. In other words, the north bridge chip is a bridge between the memory and the CPU. When the memory controller is integrated in the CPU, the speed and efficiency of an accessing operation between the CPU and the memory can be increased.

### BRIEF SUMMARY OF THE INVENTION

In accordance with an embodiment, a memory controller is coupled to a memory device comprising a first block and a second block and comprises a first register module, a first execution unit and a second register module. The first register module comprises a plurality of set registers to store a first configuration file and a second configuration file. The first execution unit computes data stored in the first block simultaneously according to the first and the second configuration files to generate a first computation result and a computation operation result. The second register module comprises a plurality of result registers to store the first and the second computation results.

In accordance with another embodiment, an accessing system comprises a memory device and a memory controller. The memory device comprises a first block and a second block. The memory controller is coupled to the memory device and comprises a first register module, a first execution unit and a second register module. The first register module comprises a plurality of set registers to store a first configuration file and a second configuration file. The first execution unit computes data stored in the first block simultaneously according to the first and the second configuration files to generate a first computation result and a computation operation result. The second register module comprises a plurality of result registers to store the first and the second computation results.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIGS. 1-3 are schematic diagrams of exemplary embodiments of an accessing system, in accordance with some embodiments.

### DETAILED DESCRIPTION OF THE INVENTION

The making and using of the embodiments of the disclosure are discussed in detail below. It should be appreciated, however, that the embodiments provide several applicable inventive concepts that can be embodied in a wide variety of specific contexts. The specific embodiments discussed are merely illustrative, and do not limit the scope of the disclosure.

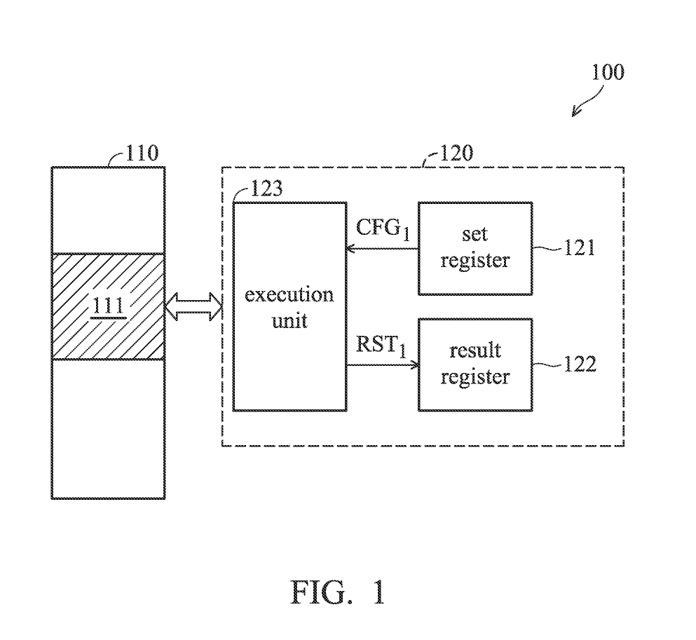

FIG. 1 is a schematic diagram of an exemplary embodiment of an accessing system, in accordance with some embodiments. The accessing system 100 comprises a memory device 110 and a memory controller 120. The memory controller 120 is coupled to the memory device 110 to access the memory device 110. In this embodiment, the memory controller 120 comprises a set register 121, a result register 122 and an execution unit 123.

The execution unit 123 computes data stored in a block 111 of the memory device 110 according to a configuration file CFG₁ stored in the set register 121 to generate a computation result RST₁ and then stores the computation result RST₁ to the result register 122. However, since the execution unit 123 searches data stored in the block only according to a single configuration file, the efficiency of the accessing system is lower.

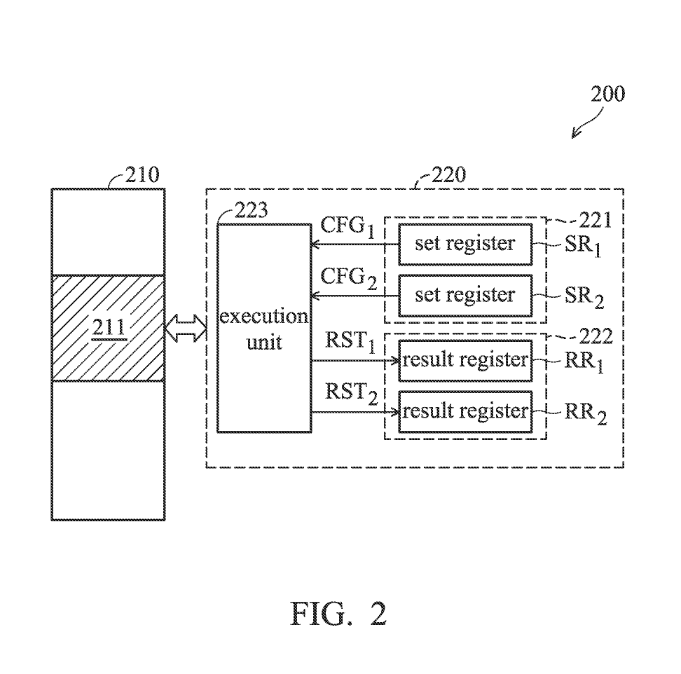

To increase the efficiency, another accessing system is provided. FIG. 2 is a schematic diagram of another exemplary embodiment of an accessing system, in accordance with some embodiments. The accessing system 200 comprises a memory device 210 and a memory controller 220. The memory device 210 stores data. The invention does not limit the kind of memory device 210. The memory device 210 may be a non-volatile memory or a volatile memory. In one embodiment, the memory device 210 is a static random access memory (SRAM).

The memory controller 220 is coupled to the memory device 210 to access data stored in the memory device 210. In this embodiment, the memory controller 220 comprises register modules 221, 222 and an execution unit 223. The execution unit 223 computes the data stored in a block 211 of the memory device 210 simultaneously according to configuration files to generate computation results and stores the computation results in the register module 222.

In this embodiment, the register module 221 comprises set registers SR₁ and SR₂ to store the configuration files CFG₁ and CFG₂, but the disclosure is not limited thereto. In other embodiments, the number of set registers is greater than 2 to store various configuration files. As shown in FIG. 1, the set register SR₁ stores the configuration file CFG₁, and the set register SR₂ stores the configuration file CFG₂.

The register module 222 comprises result RR₁ and RR₂ to store computation results RST₁ and RST₂, but the disclosure is not limited thereto. The invention does not limit the number of result registers. In other embodiments, the number of result registers is greater than 2. In one embodiment, the number of the result registers of the register module 222 is equal to the number of the set registers of the register module 221.

The execution unit 223 computes the data stored in the block 211 of the memory device 210 simultaneously according to the configuration files CFG₁ and CFG₂ to generate the computation results RST₁ and RST₂ and stores the computation results RST₁ and RST₂ in the corresponding registers according to the configuration files CFG₁ and CFG₂. In this embodiment, the execution unit 223 stores the computation result RST₁ in the result register RR₁ and stores the computation result RST₂ in the result register RR₂. Since the execution unit 223 computes data simultaneously according to several configuration files to generate several results, the efficiency of the accessing system 200 is increased.

The invention does not limit the circuit structure of the execution unit 223. Any circuit can serve as the execution unit 223, as long as the circuit is capable of computing or searching data stored in the memory device 210 and storing the computation results in registers. In one embodiment, the execution unit 223 is a packet forwarding engine (PEE).

In one embodiment, a computing operation in which the execution unit 223 computes data stored in the block 211 according to the configuration file CFG₁, is different from a computing operation in which the execution unit 223 computes data stored in the block 211 according to the configuration file CFG₂. In other words, the the configuration file CFG₁ is different from the configuration file CFG₂. For example, the execution unit 223 searches the data stored in the block 211 according to the the configuration file CFG₁ to obtain specific data with the maximum value. At this time, the execution unit 223 searches the data stored in the block 211 according to the the configuration file CFG₂ to obtain specific data with the minimum value. Therefore, the execution unit 223 generates the different computation results RST₁ and RST₂.

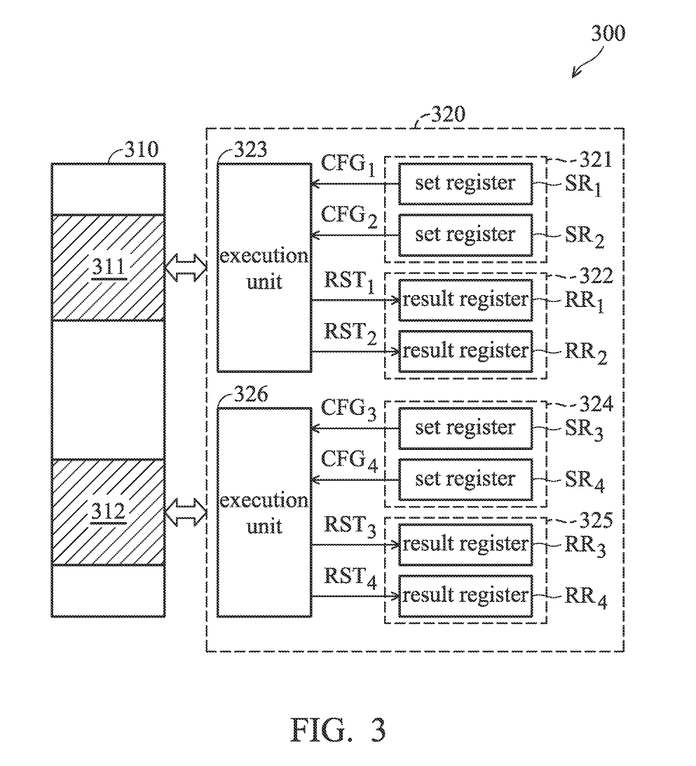

To increase the search speed, various execution units are utilized to search different blocks. FIG. 3 is a schematic diagram of another exemplary embodiment of an accessing system, in accordance with some embodiments. The accessing system 300 is similar to that shown in FIG. 2 except that the memory controller 320 further comprises register modules 324, 325 and an execution unit 326. Since the operations of the register modules 321, 322, 324 and 325 are the same and the operations of the execution units 325 and 326 are the same, the descriptions of the register modules 324, 325 and the execution unit 326 are omitted for brevity.

In this embodiment, the execution unit 323 and 326 operate simultaneously. For example, the execution unit 323 computes the data stored in the block 311 according to the configuration files CFG₁ and CFG₂, and meanwhile, the execution unit 326 computes the data stored in the block 312 according to the configuration files CFG₃ and CFG₄. The execution unit 326 generates the computation results RST₃ and RST₄.

In one embodiment, a computing operation in which the execution unit 326 computes the data stored in the block 312 according to the configuration file CFG₃, is different from a computing operation in which the execution unit 326 computes the data stored in the block 312 according to the configuration file CFG₄. In other words, the configuration file CFG₃ is different from the configuration file CFG₄. For example, the execution unit 326 computes the values of the data stored in the block 312 according to the configuration file CFG₃ to obtain an average value and computes the values of the data stored in the block 312 according to the configuration file CFG₄ to obtain specific data with a specific value.

In another embodiment, the configuration files CFG₁ and CFG₃ are the same, and the configuration files CFG₂ and CFG₄ are the same. For example, the execution unit 323 obtains the specific data with the maximum value and the specific data with the minimum value from the block 311 and the execution unit 326 obtains the specific data with the maximum value and the specific data with the minimum value from the block 312. In other embodiments, at least one of the configuration files CFG₁ and CFG₂ is different from at least one of the configuration files CFG₃ and CFG₄. For example, the execution unit 323 obtains the specific data with the maximum value and the specific data with the minimum value from the block 311, and the the execution unit 326 obtains the average value and the specific value from the block 312.

The invention does not limit the number of set registers. In one embodiment, the number of the set registers of the register module 321 is the same as or different from the number of the set registers of the register module 324. In another embodiment, the number of the result registers of the register module 322 is the same as or different from the number of the result registers of the register module 325. In some embodiments, the number of the result registers of the register module 325 is the same as the number of the set registers of the register module 324.

Since the execution unit computes data stored in the memory device according to several configuration files to generate several computation results, the accessing efficiency is increased. When several execution units operate, the accessing efficiency and speed are further increased.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A memory controller coupled to a memory device comprising a first block and a second block, comprising:
a first register module comprising a plurality of set registers to store a first configuration file and a second configuration file;
a first execution unit computing data stored in the first block simultaneously according to the first and the second configuration files to generate a first computation result and a computation operation result; and
a second register module comprising a plurality of result registers to store the first and the second computation results.

2. The memory controller as claimed in claim 1, wherein the first configuration file is different from the second configuration file.

3. The memory controller as claimed in claim 1, further comprising:
a second register module comprising a plurality of set registers to store a third configuration file and a fourth configuration file;
a second execution unit computing the data stored in the second block simultaneously according to the third and the fourth configuration files to generate a third computation result and a fourth computation result; and
a fourth register module comprising a plurality of result registers to store the third and the fourth computation results.

4. The memory controller as claimed in claim 3, wherein the first execution unit computes the data stored in the first block simultaneously according to the first and the second configuration files, meanwhile, the second execution unit computes the data stored in the second block simultaneously according to the third and the fourth configuration files.

5. The memory controller as claimed in claim 3, wherein the number of the set registers of the first register module is equal to the number of the set registers of the third register module.

6. The memory controller as claimed in claim 3, wherein the number of the set registers of the first register module is unequal to the number of the set registers of the third register module.

7. The memory controller as claimed in claim 3, wherein the number of the set registers of the first register module is equal to the number of the result registers of the second register module.

8. The memory controller as claimed in claim 3, wherein the number of the set registers of the third register module is equal to the number of the result registers of the fourth register module.

9. The memory controller as claimed in claim 3, wherein the third configuration file is different from the fourth configuration file.

10. The memory controller as claimed in claim 9, wherein at least one of the first and the second configuration files is different from at least one of the third and the fourth configuration files.

11. An accessing system comprising:
a memory device comprising a first block and a second block; and
a memory controller coupled to the memory device and comprising:
a first register module comprising a plurality of set registers to store a first configuration file and a second configuration file;
a first execution unit computing data stored in the first block simultaneously according to the first and the second configuration files to generate a first computation result and a computation operation result; and
a second register module comprising a plurality of result registers to store the first and the second computation results.

12. The accessing system as claimed in claim 11, wherein the first configuration file is different from the second configuration file.

13. The accessing system as claimed in claim 11, further comprising:
a second register module comprising a plurality of set registers to store a third configuration file and a fourth configuration file;
a second execution unit computing the data stored in the second block simultaneously according to the third and the fourth configuration files to generate a third computation result and a fourth computation result; and
a fourth register module comprising a plurality of result registers to store the third and the fourth computation results.

14. The accessing system as claimed in claim 13, wherein the first execution unit computes the data stored in the first block simultaneously according to the first and the second configuration files, meanwhile, the second execution unit computes the data stored in the second block simultaneously according to the third and the fourth configuration files.

15. The accessing system as claimed in claim 13, wherein the number of the set registers of the first register module is equal to the number of the set registers of the third register module.

16. The accessing system as claimed in claim 13, wherein the number of the set registers of the first register module is not equal to the number of the set registers of the third register module.

17. The accessing system as claimed in claim 13, wherein the number of the set registers of the first register module is equal to the number of the result registers of the second register module.

18. The accessing system as claimed in claim 13, wherein the number of the set registers of the third register module is equal to the number of the result registers of the fourth register module.

19. The accessing system as claimed in claim 13, wherein the third configuration file is different from the fourth configuration file.

20. The accessing system as claimed in claim 19, wherein at least one of the first and the second configuration files is different from at least one of the third and the fourth configuration files.
